(19) United States
(12) Patent Application Publication
(10) Pub. No.: US 2015/0081671 A1
(43) Pub. Date: Mar. 19, 2015

(54) Method and Apparatus for Receiving and Processing Media Recommendations

(71) Applicant: Ford Global Technologies, LLC, Dearborn, MI (US)

(72) Inventor: Stefan Bankowski, Royal Oak, MI (US)

(73) Assignee: Ford Global Technologies, LLC, Dearborn, MI (US)

(21) Appl. No.: 14/031,391

(22) Filed: Sep. 19, 2013

(51) Int. Cl. G06F 17/30

(52) U.S. Cl. CPC G06F 17/30053
USPC 707/722

(57) ABSTRACT

A system includes a processor configured to receive a request to assemble a recommended playlist. The processor is also configured to access one or more user-specified social media sites and obtain posted song recommendations from the one or more social media sites. Also, the processor is configured to assemble the song recommendations into a playlist. The processor is further configured to access a song-providing service and request music on the playlist from the song providing service. The processor is additionally configured to play the requested music.

### TECHNICAL FIELD

The illustrative embodiments generally relate to a method and apparatus for receiving and processing media recommendations.

### BACKGROUND

Many people will remember a time when it was common to make a mixed tape, consisting of a number of songs from various artists, in order to provide a selection of recommended music to a friend. These tapes have been replaced more recently by burned CDs, and even more recently than that, by memory media storing MP3s or other sound files.

Sharing music between friends has always been common since music has been available in transferrable media. While the concept of sharing music may be old, many opportunities to improve on the processes for sharing music still exist.

U.S. Patent Application 2013/0030645 generally relates to an infotainment system for delivering content to multiple occupants of a vehicle. The infotainment system includes: an occupant detector configured to receive characteristic data for occupants of the vehicle and generate a profile for each occupant of the vehicle; a recommendation engine that analyzes the profiles of the vehicle occupants; and a content delivery engine that deliver content to one or more of the vehicle occupants in accordance with the analysis of the profiles of the vehicle occupants.

U.S. Patent Application 2012/0271882 generally relates to system and application are provided that enable social media shuffle functionality. Social media shuffle functionality allows users of the social media system to enjoy a variety of media that is not stored in their profile by allowing them access to all media stored in a media catalog or otherwise available to a friend. A social media shuffle operation is provided whereby a user can easily enjoy a wide variety of media with minimal user effort.

### SUMMARY

In a first illustrative embodiment, a system includes a processor configured to receive a request to assemble a recommended playlist. The processor is also configured to access one or more user-specified social media sites and obtain posted song recommendations from the one or more social media sites. Also, the processor is configured to assemble the song recommendations into a playlist.

The processor is further configured to access a song-providing service and request music on the playlist from the song providing service. The processor is additionally configured to play the requested music.

In a second illustrative embodiment, a computer-implemented method includes receiving a request to assemble a recommended playlist. The method also includes accessing one or more user-specified social media sites. The method further includes obtaining posted song recommendations from the one or more social media sites. The method additionally includes assembling the song recommendations into a playlist. Also, the method includes accessing a song-providing service and requesting music on the playlist from the song providing service. The method additionally includes playing the requested music.

In a third illustrative embodiment, a non-transitory computer readable storage medium stores instructions, that, when executed by a processor, cause the processor to perform a method including receiving a request to assemble a recommended playlist. The method also includes accessing one or more user-specified social media sites. Further, the method includes obtaining posted song recommendations from the one or more social media sites and assembling the song recommendations into a playlist. The method additionally includes accessing a song-providing service. The method also includes requesting music on the playlist from the song providing service and playing the requested music.

### BRIEF DESCRIPTION OF THE DRAWINGS

FIG. 1 shows an illustrative vehicle computing system;

FIG. 2 shows an illustrative example of a music list building process;

FIG. 3 shows an illustrative example of a further list building process;

FIG. 4 shows an illustrative example of a list handling process; and

FIG. 5 shows an illustrative example of a list requesting and handling process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

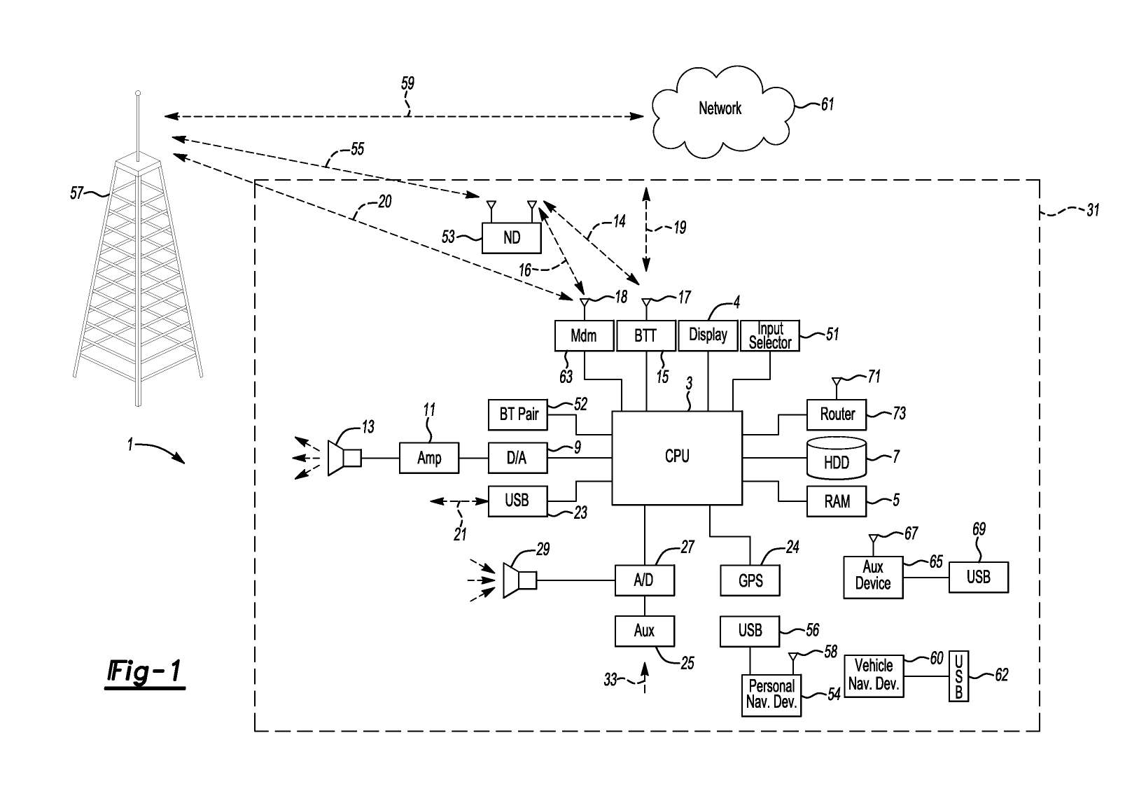

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a universal serial bus (USB) input 23, a global positioning system (GPS) input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a controller area network (CAN) bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as personal navigation device (PND) 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, personal digital assistant (PDA), or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the central processing unit (CPU) is instructed that the onboard BLUETOOTH transceiver will be paired with a BLUETOOTH transceiver in a nomadic device.

Data may be communicated between CPU 3 and network 61 utilizing, for example, a data-plan, data over voice, or dual-tone multi-frequency (DTMF) tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as infrared data association (IrDA)) and non-standardized consumer infrared (IR) protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

The illustrative embodiments provide examples of a system and/or method for allowing infotainment system users to receive both playlist recommendations and the accompanying media. This lets music sharing take on a whole new dimension, as, utilizing the illustrative embodiments, users can combine recommendations, and essentially have entire listening lists provided by any number of friends.

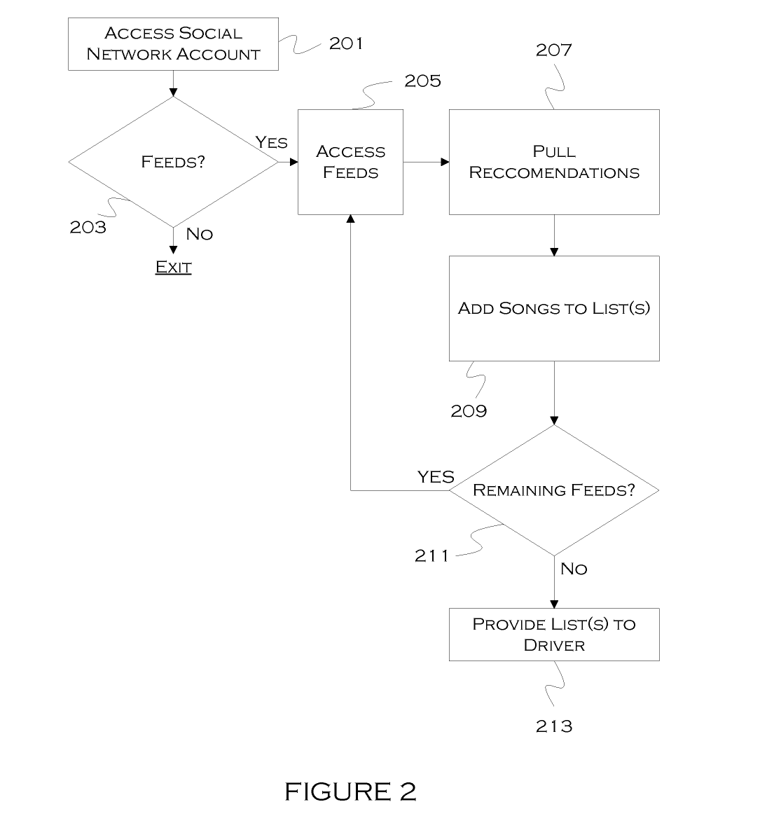

FIG. 2 shows an illustrative example of a music list building process. In this illustrative example, the lists are provided through a social networking account. Users can either post recommendations on their own pages (or feeds, etc), which can be accessed by friends, or the users can post the recommendations directly to a friend's page (or feed, etc). For example, someone could tweet a song that they liked using the service TWITTER and others could pull the recommendation from the feed. Or, using, for example, FACEBOOK, a user could post a recommendation to a friend's page, and the process could pull the recommendation from the page. In at least one example, the recommendation may be associated with a music service that will provide the song, or, in another example, the process could find the song in a music service to which a user subscribes, owns, etc.

In the illustrative example shown in FIG. 2, the process accesses a social networking account (or accounts) from which music recommendations can be obtained 201. As noted, this can be a user's own page, or something which a user “follows” such as a feed. The process then checks the account to see if there are any feeds (or recommendations) related to music, playlists, etc. 203. If there are not, the process can exit, or access another account, or take any other suitable action.

If there is at least one source for digital music recommendations, the process will access the feed (or recommendation, list, etc.) 205 and pull any recommendation(s) from the source 207. Any songs pulled in this manner can be added to a playlist 209. The playlist may correspond to a single user, any number of users, a client, or just be a list assembled for the momentary use by the requesting user.

If there are remaining sources of music 211, the process can repeat until all sources of music recommendations have been processed. In this manner, multiple user recommendations can be accumulated into one list. So if a person has several friends from which music is desired, all the recommendations from those friends can be accumulated into a single list. Once this is completed, the list(s) can be provided to a user 213. It is also possible that multiple lists can be assembled based on recommenders, music genres, etc., and then the user can be presented with the multiple lists and choose to combine them, listen to them independently, etc. The lists can be combined in any suitable manner (linear, random, etc).

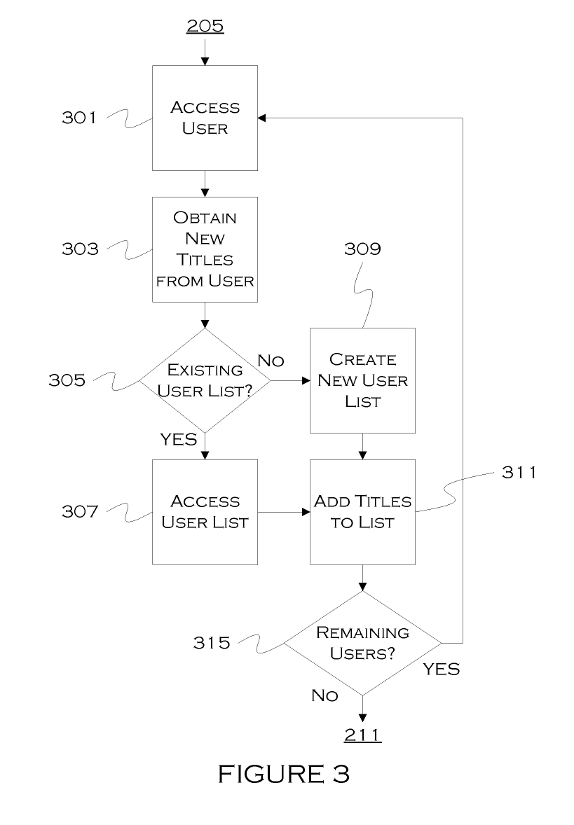

FIG. 3 shows an illustrative example of a further list building process. This exemplary process shows the handling of multiple recommending users, and one illustrative manner in which the songs from these users might be assembled. In this illustrative example, the process accesses a first user/recommender 301 to obtain titles from that user. Since the user may have already provided some recommendations on a previous list, the process may only check for new recommendations 303. Or, the process could check for all available recommendations from that user.

The process also checks to see if there is an existing list for that particular user 305. If the user/recommender has already provided some recommendations, a list for those recommendations may already exist. In this illustrative example, the process may then access that existing list 307 and add any new titles to the existing list 311. Or, if there is no list for that user, or if some new list is being assembled, the process may create a new list 309 and add the titles to that list. In the case of a new list, for example, all recommendations may be added. Recommendations can also be pulled based on parameters, such as, but not limited to, date recommended, genre, ratings, artist, album, etc.

Finally, in this example, the process checks to see if any additional users exist from whom to pull recommendations 313. If there are no additional users, the process can exit. Otherwise, the process can repeat until all users have been handled.

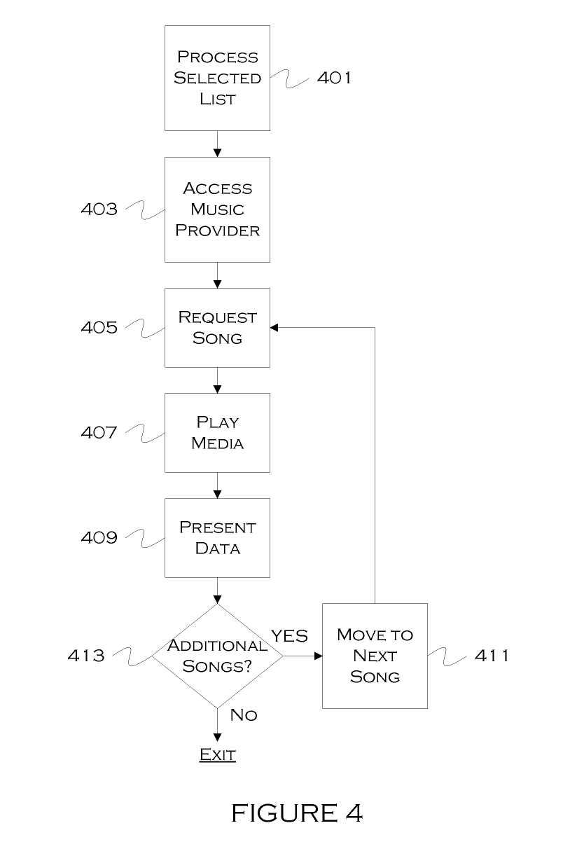

FIG. 4 shows an illustrative example of a list handling process. In this illustrative example, the process has received at least one list which has been selected for playback (in a vehicle, for example). The process receives the list 401 and accesses a music providing service 403. The music providing service could be a service where songs are purchased, a subscription based service, a free service, etc. A particular service could be designated for certain songs as well, whereas a default service could be used if no particular service is specified.

The process can request the next song from a providing service 407 and receive the music/media data along with any other relevant data, such as song length, title, album, artist, etc. This data can be presented on an in-vehicle display 409. Information relating to a recommending user can also be presented, so that the listener knows where the recommendation came from. The user could even be given an option to rate the song and/or the recommender, which could be used in the future for gathering recommendations.

For example, if the user wanted forty five minutes of music, the process could select music based on the highest rated recommenders that spans a forty five minute period. So a “5 star” recommender could have twenty minutes of music recommended, and then the remaining twenty five minutes may come from one or more lower ranked recommenders.

In the example shown in FIG. 4, if there are additional songs on the playlist 413, the process could move to a next song on the list 411 (preferably before a current song ends, although not necessarily) and repeat the process until all remaining songs have been played.

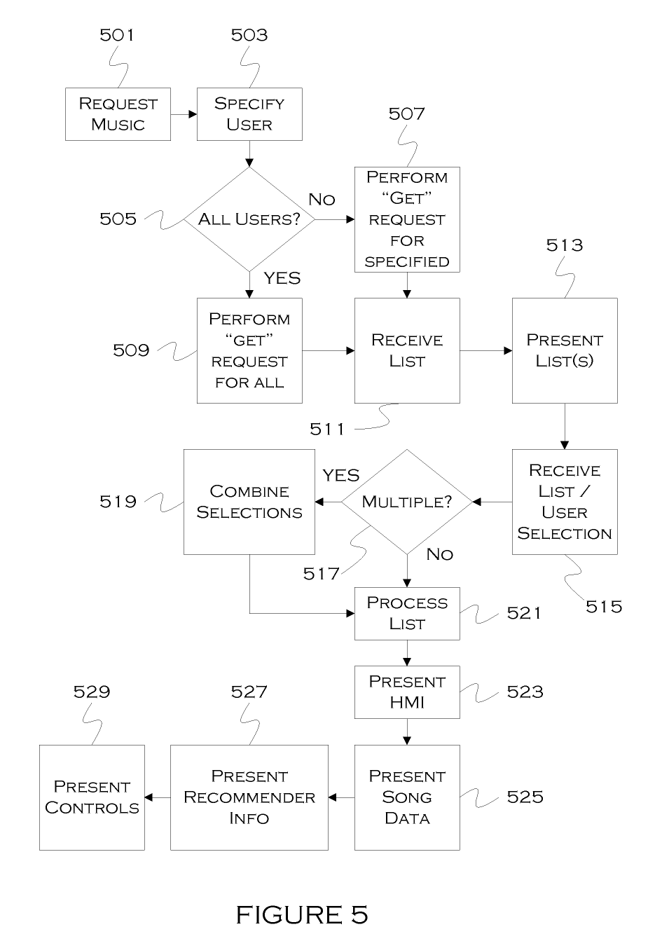

FIG. 5 shows an illustrative example of a list requesting and handling process. In this illustrative example, the process begins with a listener requesting that one or more playlists be assembled 501. For example, the user may interact with an in-vehicle interface to request a playlist from one or more recommenders. Next, in this example, the user may specify from whom the lists are desired, or, in another example, the user may specify a personal account (such as FACEBOOK) from which the recommended songs are to be pulled 503.

Also, the listener may specify multiple recommenders, or have saved preferences relating to multiple recommenders. Thus, the user may specify “all users” 505 to pull from all recommenders, or, for example, may specify some discreet number of recommenders.

If “all” recommenders are requested, the process may perform a “get all” request 509, which will iteratively (for example) access all recommenders and pull selections from each of the recommenders into one or more lists 511. Or, in the alternative, the process may access recommendations from the specified recommenders 507 and assemble those recommendations into one or more lists 511. The assembled list(s) may then be presented to the user for selection of one or more of the assembled lists 513.

The process receives selection of one or more of the lists, from the listener 515. If multiple lists are selected 517, these lists may be combined (in a suitable manner) into a single playlist 519. Or, if only a single list is selected, there may be some handling (randomization, sorting) of the single list. The process may then use one or more music services to process the lists 521, such as is shown in FIG. 4 (by way of non-limiting example).

The process may also present an HMI (human machine interface) in the vehicle that provides various information relating to the list and/or current selection being played 523. Song data can be presented 525, as can recommender information 527. Additionally, play controls can be presented 529, if the HMI is suitable for such presentation.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a processor configured to:
receive a request to assemble a playlist;
access one or more user-specified social media sites;
obtain posted song recommendations from the one or more social media sites;
assemble the song recommendations into a playlist;
access a song-providing service;
request music on the playlist from the song providing service; and
play the requested music.

2. The system of claim 1, wherein the social media sites include a site where recommendations are posted for a specified listener.

3. The system of claim 1, wherein the social media sites include a site where a recommendation feed is posted by a recommender.

4. The system of claim 1, wherein at least one song recommendation includes a specified song-providing service, and wherein the processor is configured to access the specified song-providing service for playback of the song recommendation including the specified song-providing service.

5. The system of claim 1, wherein the processor is configured to access a user-specified song providing service to request music.

6. The system of claim 1, wherein the request to assemble a playlist includes a specification of a recommender, and wherein the processor is configured to obtain posted song recommendations from the specified recommender.

7. The system of claim 6, wherein the request to assemble a playlist includes a specification of a plurality of recommenders, and wherein the processor is configured to obtain posted song recommendations from the specified recommenders and wherein the processor is configured to assemble the song recommendations into a single playlist.

8. The system of claim 6, wherein the request to assemble a playlist includes a specification of a plurality of recommenders, and wherein the processor is configured to obtain posted song recommendations from the specified recommenders and wherein the processor is configured to assemble the song recommendations into a playlist for each recommender, wherein the playlist for each recommender only includes songs recommended by the recommender.

9. A computer-implemented method comprising:
receiving a request to assemble a playlist;
accessing one or more user-specified social media sites;
obtaining posted song recommendations from the one or more social media sites;
assembling the song recommendations into a playlist;
accessing a song-providing service;
requesting music on the playlist from the song providing service; and
playing the requested music.

10. The method of claim 9, wherein the social media sites include a site where recommendations are posted for a specified listener.

11. The method of claim 9, wherein the social media sites include a site where a recommendation feed is posted by a recommender.

12. The method of claim 9, wherein at least one song recommendation includes a specified song-providing service, and wherein the accessing includes accessing the specified song-providing service for playback of the song recommendation including the specified song-providing service.

13. The method of claim 9, wherein the accessing includes accessing a user-specified song providing service to request music.

14. The method of claim 9, wherein the request to assemble a playlist includes a specification of a recommender, and wherein the obtaining includes obtaining posted song recommendations from the specified recommender.

15. The method of claim 14, wherein the request to assemble a playlist includes a specification of a plurality of recommenders, and wherein the obtaining includes obtaining posted song recommendations from the specified recommenders and wherein the assembling includes assembling the song recommendations into a single playlist.

16. The method of claim 14, wherein the request to assemble a playlist includes a specification of a plurality of recommenders, and wherein the obtaining includes obtaining posted song recommendations from the specified recommenders and wherein the assembling includes assembling the song recommendations into a playlist for each recommender, wherein the playlist for each recommender only includes songs recommended by the recommender.

17. A non-transitory computer readable storage medium, storing instructions, that, when executed by a processor, cause the processor to perform a method comprising:
receiving a request to assemble a playlist;
accessing one or more user-specified social media sites;
obtaining posted song recommendations from the one or more social media sites;
assembling the song recommendations into a playlist;
accessing a song-providing service;
requesting music on the playlist from the song providing service; and
playing the requested music.

18. The storage medium of claim 17, wherein the social media sites include a site where recommendations are posted for a specified listener.

19. The storage medium of claim 17, wherein the social media sites include a site where a recommendation feed is posted by a recommender.

20. The storage medium of claim 17, wherein at least one song recommendation includes a specified song-providing service, and wherein the accessing includes accessing the specified song-providing service for playback of the song recommendation including the specified song-providing service.
